(19) United States
(12) Patent Application Publication
(10) Pub. No.: US 2003/0025585 A1
(43) Pub. Date: Feb. 6, 2003

(54) Method for manufacturing electrical components

(76) Inventor: Sauro Macerini, Arezzo (IT)

Correspondence Address: Waddey & Patterson, P.C., AmSouth Center, Suite 302, 200 Clinton Avenue, Huntsville, AL, 35801, US

(21) Appl. No.: 09/923,286

(22) Filed: Aug. 6, 2001

(51) Int. Cl. H01F 7/06; H01F 27/06

(52) U.S. Cl. 336/65; 29/602.1; 29/606

(57) ABSTRACT

A method for producing electronic components having a plurality of electrically conductive windings that includes the steps of connecting a plurality of segments of electrically conductive material to a container to form a plurality of half-turns, and mounting the combination of the container and the half-turns on a mounting structure having a plurality of electrically conductive tracks by connecting the half-turns to the plurality of electrically conductive tracks. In alternative embodiments, the segments are formed into half-turns and then connected to a container or a support structure. The resulting combination of the half-turns and electrically conductive tracks forms the plurality of conductive windings. The method may be used to produce coils, inductors, and transformers.

### BACKGROUND OF THE INVENTION

The present invention relates generally to a method for producing electric and electronic components, such as coils, transformers, and simple and multiple inductors. More particularly, the present invention relates to a method for producing electrically conductive windings for electric and electronic components.

Currently, electrically conducting windings are produced by winding copper wire, which is painted with insulating paint, around a ferro-magnetic core. This process is time-consuming and, as a result, is expensive. In an attempt to reduce the costs associated with this type of operation, companies usually use lower-cost labor in factories other than those factories that actually use the electric components to produce electronic circuits. This solution is not totally satisfactory, however, because the process is still time-consuming.

In addition to being time-consuming, the present method of producing electric components also has several other disadvantages. First, the electrically conductive wire must be painted with insulating paint. Second, electric components produced using this method disperse high levels of magnetic flows. Third, it is difficult to dissipate the heat generated inside of the electric component produced using this method. Finally, the current method of producing electric components is very difficult to automate.

### SUMMARY OF THE INVENTION

Accordingly, one object of the present invention is to provide a method for the production of electric windings that does not have the above-described disadvantages. More specifically, one object of the present invention is to provide a method of producing electric components that is easy to automate.

Another object is to provide a method which is particularly flexible, and which, with few interventions, makes it possible to produce windings consisting of a variable number of turns, connected in parallel and/or in series.

A further object of the present invention is to provide a method that makes it possible to obtain electric components that disperse low levels of magnetic flows.

Another object of the present invention is to provide a method of producing electric components that does not require painting the conductive windings with insulating paint.

Still another object is to provide a method of producing electric components that include a means for dissipating heat generated by the electric components.

These and other objects and advantages, which will become apparent to persons skilled in the art by reading the following description, are obtained by a method for manufacturing an electronic component that includes the steps of connecting a plurality of segments of electrically conductive material to a support structure to form a plurality of half-turns, and mounting the combination of the support structure and the plurality of half-turns to a mounting structure by connecting the plurality of half-turns to a plurality of electrically conductive tracks defined in the mounting structure.

In one embodiment, the method includes the steps of connecting a plurality of segments of electrically conductive material to a container to form a plurality of u-shaped half-turns, and mounting the combination of the container and the plurality of half-turns to a mounting structure by connecting the plurality of half-turns to a plurality of electrically conductive tracks defined in the mounting structure. In a variation of this embodiment, the segments are cut out of a sheet of electrically conductive material with each segment connected to an inner and outer ring to form a dial-shaped structure. In this variation, the dial-shaped structure is connected to the container, the segments are separated from the inner and outer rings, and the segments are folded onto the container to form the half-turns. In another variation of this embodiment, the method further includes the step of inserting a ferro-magnetic core into the container. In still another variation of this embodiment, the method includes the step of wrapping the ferro-magnetic core with an electrically conductive wire to form a transformer.

In a second embodiment, the method includes the steps of connecting a plurality of half-turns of electrically conductive material to a container having a plurality of seats defined in an inner and outer surface of the container, and mounting the combination of the container and the plurality of half-turns to a mounting structure by connecting the plurality of half-turns to a plurality of electrically conductive tracks defined in the mounting structure. In a variation of this embodiment, the method further includes the step of inserting a ferro-magnetic core into the container. In another variation of this embodiment, the method includes the step of wrapping the ferro-magnetic core with an electrically conductive wire to form a transformer. In still another variation, the half-turns are connected to the container using a cover.

In a third embodiment, the method includes the steps of connecting a plurality of half-turns of electrically conductive material to a container having a plurality of seats defined in an outer surface of the container and partially along a front surface of the container, and mounting the combination of the container and the plurality of half-turns to a mounting structure by connecting the plurality of half-turns to a plurality of electrically conductive tracks defined in the mounting structure. In a variation of this embodiment, the method includes the step of folding a plurality of panels connected together linearly using a plurality of joining portions into an annular shape to form the container. In another variation, the method includes the step of producing the plurality of half-turns by cutting a plurality of segments out of a rectangular latten, forming a resilient tab in a portion of each segment, and folding the segments into u-shaped half-turns. In still another variation of this embodiment, the method includes the step of inserting a ferro-magnetic core into the container. In yet another variation of this embodiment, the method includes the step of wrapping the ferro-magnetic core with an electrically conductive wire to form a transformer. In another variation, the half-turns are connected to the container using a cover.

In a fourth embodiment, the method includes the steps of connecting a plurality of half-turns to a disk, and mounting the combination of the disk and the plurality of half-turns to a mounting structure by connecting the plurality of half-turns to a plurality of electrically conductive tracks defined in the mounting structure. In a variation of this embodiment, the method includes the step of inserting a ferro-magnetic core into a u-shaped opening formed by the half-turns. In another variation of this embodiment, the method includes the step of wrapping the ferro-magnetic core with an electrically conductive wire to form a transformer. In still another variation, the method includes the step of connecting a thermal dissipater to the disk.

In each embodiment, the turns formed by the half-turns and the conductive tracks can be connected in various ways in order to obtain a variable number of turns in series and/or parallel. Using the method of the present invention, an intermediate component including a plurality of half-turns connected to a container can be obtained that has a very low cost, can be produced using an automated production cycle (for example, using a standard machine for mounting surface mounted components), and, depending on how the ends of the individual half-turns are connected to one another, can provide an inductive component with variable characteristics. For example, the individual half-turns can be connected to one another in series in order to form a single winding having a number of turns corresponding to the number of half-turns. Or, the half turns can be connected in parallel by forming a single winding with each individual half-turn. Alternative embodiments may include half-turns connected both in series and parallel.

Furthermore, in each embodiment, the intermediate component of the support structure (or the container) and the half-turns may be manufactured by one company and supplied to a second company, which connects the intermediate component to the mounting structure. In addition, the second company may insert one or more farro-magnetic cores into the intermediate component before connecting it to the mounting structure.

Finally, each embodiment may have more than one series of half-turns in order to form multiple windings. In embodiments that include a ferro-magnetic core, it is possible to produce transformers or multiple inductances using a single ferro-magnetic core.

The invention will be better understood by means of the following description and the attached drawings, which shows non-limiting embodiments of the invention.

### BRIEF DESCRIPTION OF THE DRAWINGS

FIG. 1 is a cross-sectional view of a container used in one embodiment of the present invention.

FIG. 2 is a plan view according to section lines II-II in FIG. 1.

FIG. 3 is a plan view of a plurality of segments of electrically conductive material used in one embodiment of the present invention.

FIG. 3A is a plan view of one segment from the plurality of segments shown in FIG. 3.

FIG. 4 is a longitudinal cross-sectional view of the container from FIG. 1 with the plurality of segments from FIG. 3 connected to it.

FIG. 4A is an enlarged view of the lower right hand corner of the container shown in FIG. 4 showing a portion of one segment folded toward the inside of the container.

FIG. 4B is an enlarged view of the lower right hand corner of the container shown in FIG. 4 showing a portion of one segment folded toward the outside of the container.

FIG. 5 is an isometric view of the container in FIG. 4 with the segments from FIG. 3 connected to it to form half-turns.

FIG. 6 is a bottom view according to section lines VI-VI in FIG.5.

FIG. 7 is a top view according to section lines VII-VII in FIG. 5.

FIG. 8 is a longitudinal cross section of the container, with the ferro-magnetic core inserted in it, and prepared for application on a printed circuit board.

FIG. 9 is a partial schematic plan view according to IX-IX in FIG. 8, of the printed circuit board.

FIGS. 10 and 11 are two cross sections similar to the cross section in FIG. 8, showing two variations of the present invention.

FIG. 12 is a cross section similar to the cross section in FIG. 4 showing the half-turns integrated into the container.

FIG. 13 is a front view of an intermediate support for mounting at right angles to the board that supports the printed circuit.

FIG. 14 is a perspective view of the support in FIG. 13, with a container mounted on it.

FIG. 15 is an exploded perspective view of a second embodiment of the present invention.

FIG. 16 is a perspective view of an assembly of half-turns in a rectilinear arrangement.

FIG. 17 is a lateral view, partially in cross section, of a half-turn of the assembly in FIG. 16.

FIGS. 18 and 19 are perspective views from above and from below of an improved container according to the present invention.

FIG. 20 is an exploded perspective view of a third embodiment of the present invention produced by means of the container in FIGS. 18 and 19.

FIG. 21 is a plan view of a support structure with laminar development for a fourth embodiment of the invention.

FIG. 22 is a perspective view of an individual half-turn to be applied to the laminar support component in FIG. 21.

FIG. 23 is a plan view according to line XXIII-XXIII in FIG. 24 of the laminar support component in FIG. 21 with the half turns mounted on it.

FIG. 24 is a cross section according to XXIV-XXIV in FIG. 23.

FIG. 25 is a cross section similar to the cross section in FIG. 24, with a farro-magnetic core inserted in the opening formed by the half-turns.

FIGS. 26 and 27 are plan views of the two surfaces of a laminar support provided with the conductive tracks onto which the half-turns are soldered.

FIG. 28 is a cross section similar to the cross section in FIG. 25, with the laminar support mounted.

FIG. 29 is a plan view similar to the view in FIG. 23, with a ferro-magnetic core provided with a wire winding inserted in the space defined by the half-turns.

FIG. 30 is a cross section similar to the cross section in FIG. 28, with a farro-magnetic core provided with a wire winding for the production of a transformer.

### DETAILED DESCRIPTION OF THE INVENTION

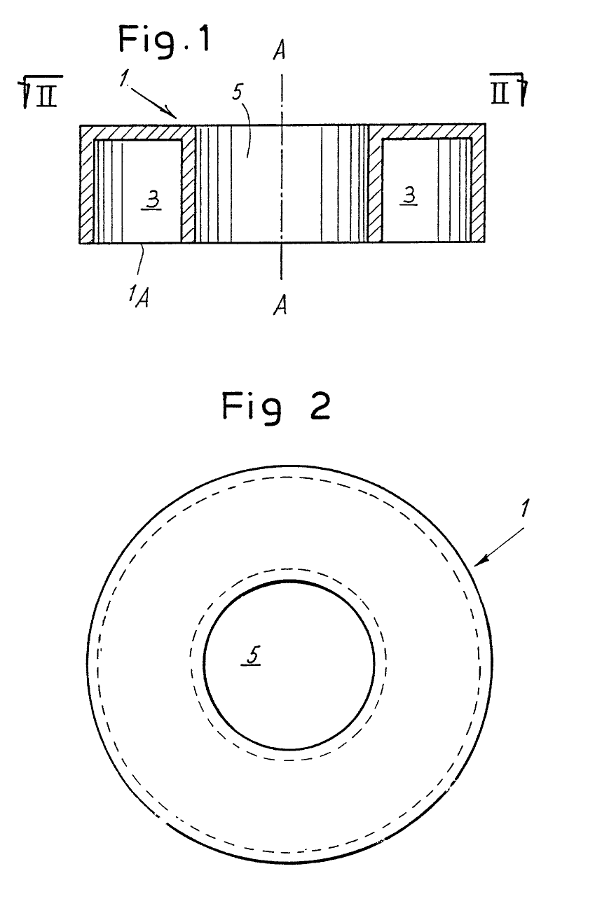

Referring to FIG. 1, a first embodiment of the present invention is shown. FIG. 1 shows in longitudinal cross section a container 1 made of electrically insulating material. The container may be made from a synthetic resin and is preferably thermally conductive. The container extends annularly because it is designed for use with a toroidal winding. However, this shape is non-limiting, and as will become more apparent hereinafter, the same inventive concept can be applied to containers and windings with various shapes.

The container 1 has an inner space 3, which is open at the base, and a central through hole 5. A plurality of half-turns 7, i.e., open turns, of electrically conductive laminar material, such as copper, are applied to the container 1. The half-turns have a thickness that is determined by the amount of current that will flow through the half-turns. In one embodiment, the thickness is between approximately 0.1 mm and 3 mm. In alternative embodiments, however, the thickness may vary.

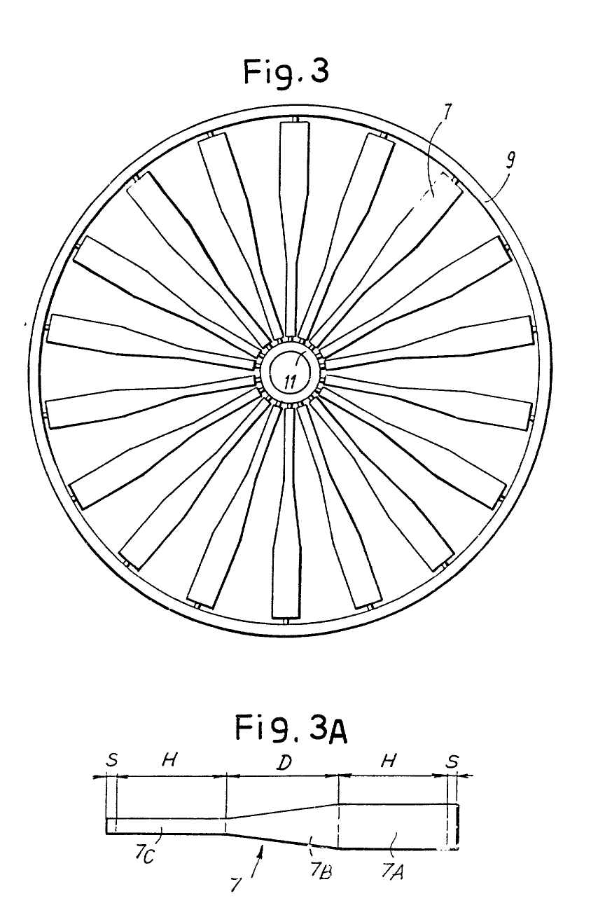

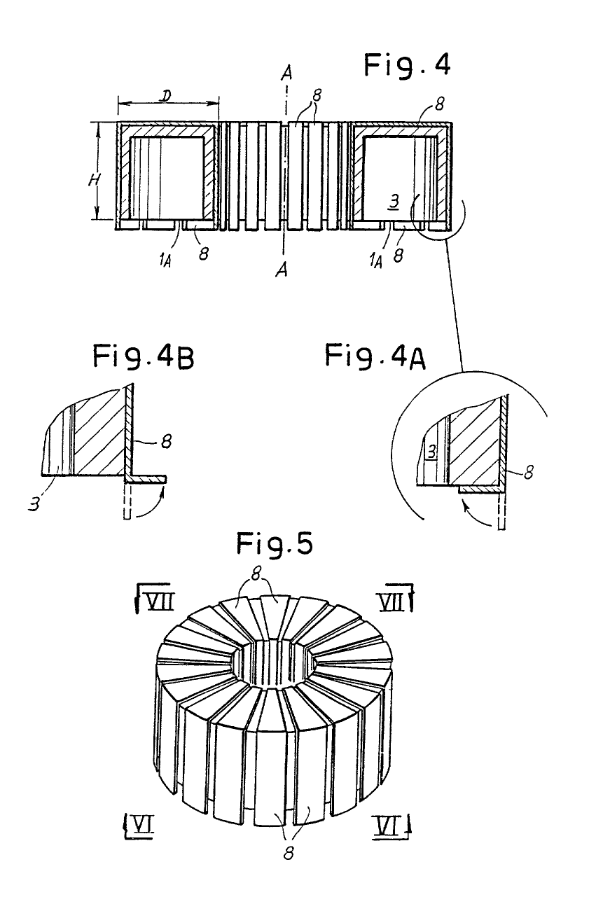

FIG. 3 shows a development in plan view of a sheet of conductive material cut to form a series of shaped segments 7 (twenty-four in the example illustrated) disposed in the shape of a dial, each connected at an outer radial end to a ring 9, and at an inner radial end to a ring 11. Each segment 7 (see FIG. 3A) includes a first rectangular portion 7A with a length H+S, a second trapezoidal intermediate portion 7B with a height D, and a third rectangular portion 7C, with a width smaller than the portion 7A, but with the same length (H+S). The dimensions H and D correspond respectively to the height of the container 1 and to difference between the outer diameter of the latter and the inner diameter of the through hole 5, as shown in FIG. 4.

The assembly of segments 7 is applied around the container 1, by folding at a right angle the portions 7A and 7C relative to the intermediate portion 7B, to obtain around the container 1 an arrangement of half-turns 8 in the shape of a “U”, as can be seen in FIG. 4. By means of this operation, which can be carried out by means of a punch tool, the rings 9 and 11 are detached from the segments 7, and removed. The turns 8 formed by the folded segments 7 are stabilized on the container 1 by means of suitable resin bonding. The resin bonding can be carried out before completing punching of the ring 11 in order to retain the segments 7 in the correct position around the container 1.

Each half-turn 8 includes two rectangular portions that extend parallel to the axis A-A of the container 1, and are defined by the portions 7A and 7C of the respective segments 7, and a trapezoidal intermediate portion, consisting of the portion 7B of the segment 7, which extends radially on the upper surface of the container 1. Because the portions 7A and 7B of the segments 7 have a length which is longer (by an amount S) than the height H of the container 1, each half-turn 8 formed by the segments 7 projects relative to the lower edge 1A of the container 1 by an amount S, and can be folded as shown in detail in FIG. 4A, against this edge 1A, or toward the exterior, as shown in FIG. 4B.

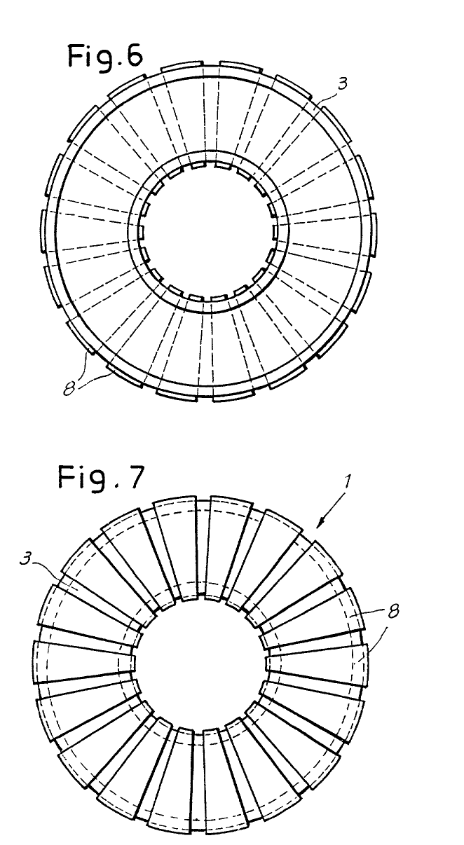

As already stated, the assembly of the turns 8 is resin-bonded onto the container 1, in order to obtain stability. For clarity, the resin bonding is not shown in the attached drawings. The container thus obtained is shown in FIGS. 5 to 7.

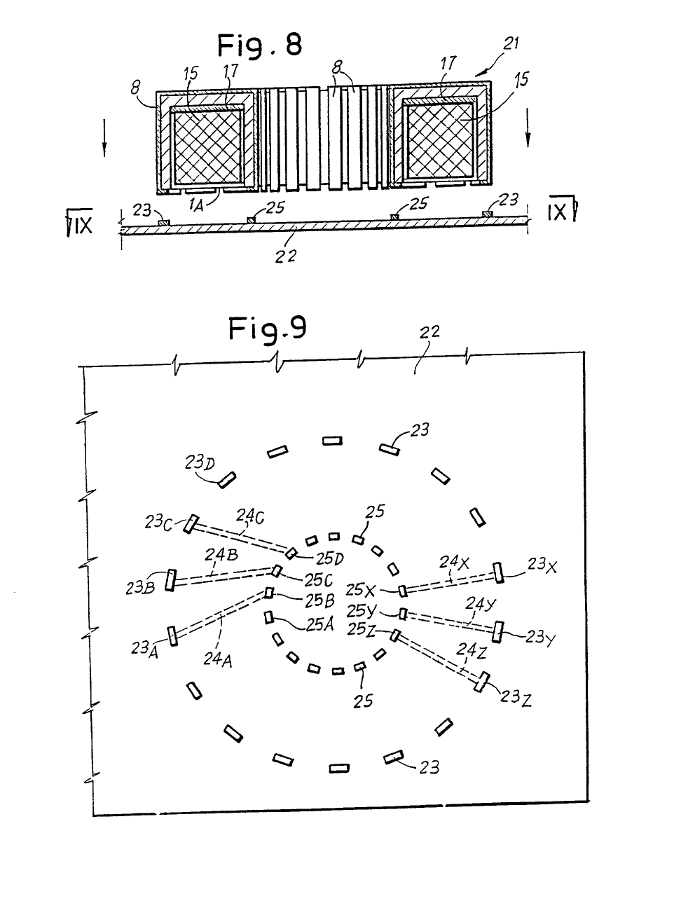

The container 1 with the half-turns 8 can be used to produce a component wound in the air, in which case the inner space 3 remains empty, or to produce an inductive component, for example a coil, by introducing into the space 3 of the container 1 a ferro-magnetic core 15 (see FIG. 8). The ferro-magnetic core is glued by means of a layer of synthetic resin 17, which is applied to the base of the space 3 as shown in FIG. 8. As an alternative, the ferro-magnetic core 15 can be embedded inside the container 1, for example by providing a projection along the edges of the space itself, into which the core is snapped.

The component thus obtained, which is generally indicated as 21, can be applied to a printed circuit produced on a mounting support 22. The mounting support 22 includes a plurality of welding pads, which are of a number equivalent to twice that of the half-turns 8, and are disposed according to two circular alignments, corresponding to the alignments of the ends of the half-turns 8. The arrangement of the welding pads can be seen in particular in FIG. 9, where the individual pads are indicated as 23 (outer alignment) and 25 (inner alignment). The individual pads 23, 25 are connected to one 45 another electrically by means of suitably arranged conductive tracks, according to the type of connection to be obtained between the turns.

For example, in the left part of FIG. 9, there are shown in broken outline three connection tracks 24A, 24B, 24C, between the pads indicated as 23A, 23B, 23C, 25B, 25C, 25D. More specifically, the tracks 24A, 24B, 24C connect to one another in pairs the pads 23A-25B, 23B-25C, 23C-25D. When the component 21 is applied to the circuit produced on the board 22, the pads 23, 25 are connected to one another by individual turns 8 with homologous pairs, i.e.: 23A-25A, 23B-25B, 23C-25C, 23D-25D. By this means, the tracks 24A, 24B, 24C join the half-turns 8 which are connected to the pads 23A-23D and 25A-25D in series, forming a single winding of three complete turns in series.

In the right-hand part of FIG. 9, there are illustrated pads 23X, 23Y, 23Z and 25X, 25Y, 25Z, which are connected by tracks 24X, 24Y, 24Z, such as to form, with three half-turns 8 applied to the pads 23X-25X, 23Y-25Y and 23Z-25Z, three complete turns which can be connected in parallel. The half-turns 8 are connected by their own ends to homologous pads (23X, 25X; 23Y, 25Y; 23Z, 25Z).

The connection between the ends of the half-turns 8 and the pads 23, 25 takes place by soldering, by remelting, or by another equivalent means.

By arranging the conductive tracks 24 in an appropriate manner on the board 22, it is possible to produce windings with any arrangement (series and/or parallel) of the twenty-four half-turns 8 of the component 21. With a single standard component, which includes the container 1 and the half-turns 8 applied to the latter, it is possible to produce components 21 of various types. The arrangement of the conductive tracks 24 is selected on the basis of the number of turns and/or the current that must flow in them.

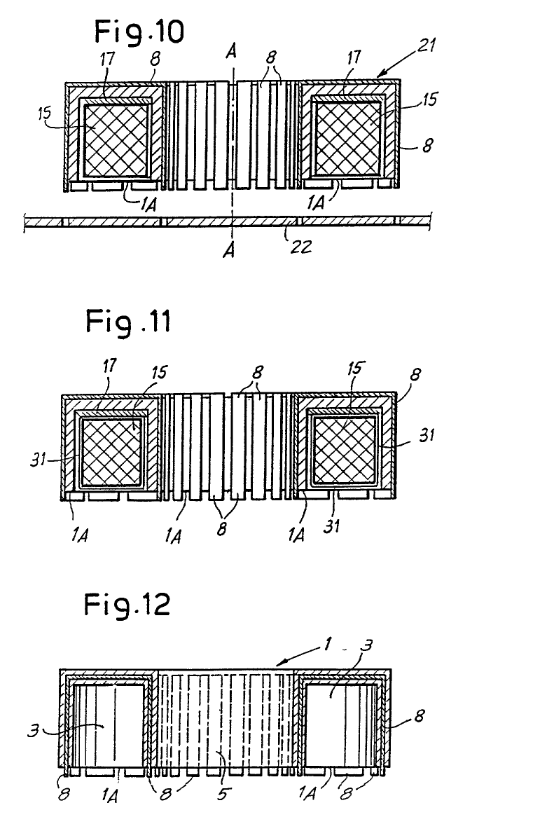

FIG. 10 shows a cross section similar to FIG. 8, in which the ends of the half-turns 8 produced on the component 21 are not folded against the edge 1A of the inner space of the container 1, but continue to project from the latter, in order to pass through holes which are provided in the board 22. In this case, the connection between the ends of the half-turns 8 is again provided by means of tracks produced on the board 22, but the soldering takes place for example in wave form, by operating on the side opposite the side of application of the component 1.

FIG. 11 shows by way of example a component 21 of a different kind. Whereas in the previous cases the component 21 substantially consisted of an inductance formed by a single winding, consisting of the half-turns 8 closed by the conductive tracks 24, in FIG. 11 the component 21 constitutes a transformer, in which the half-turns 8 form the secondary winding and the primary winding consists of a single, insulated metal wire 31, such as a painted copper wire, wound around the core 15. Alternatively, both the primary and secondary winding can consist of half-turns 8, which are disposed on two superimposed layers and separated by a resin.

FIG. 12 shows a different embodiment of the container 1 and the half-turns 8. In this case, the half-turns 8 are integrated into the container 1 by inserting the half-turns 8 into a mold and injecting synthetic resin into the mold. In this embodiment, a second series of half-turns can be applied on the container 1, by means of the technique previously described, to form two windings around the space 3 of the container 1. As discussed previously, a ferro-magnetic core may also be inserted into the container to form a transformer.

As initially stated, the toroidal shape of the ferro-magnetic core and the container 1 are not compulsory, since the above-described inventive concept can also be produced by means of cores in the shape of an “E+E”, “C+C”, or with another geometry. According to the shape of the core, it is also possible to use several containers instead of a single container as indicated in FIG. 1. In this case, several containers of various shapes support the plurality of half-turns and are placed on the ferro-magnetic core. Each container includes a section in the shape of a “U”, which is open at the ends, and which, when combined with the adjacent containers, forms an opening to contain the ferro-magnetic core.

In the preceding description, the individual half-turns are produced by punching a laminar sheet of conductive material, such as copper, in order to obtain a semi-finished product of the type illustrated in FIG. 3. In alternative embodiments, however, it is possible to produce the individual half-turns 8 and apply them one by one to the container 1 using an assembly robot. For example, individual segments 7 can be produced by punching them from a copper sheet and then folding them into the shape of a “U”. Again as an alternative, the individual segments 7 can be produced from a strip of conductive material, and subsequently detached individually, folded, and applied to the container. In this case, the strips of punched material form a type of loader for half-turns.

Similar advantages can be obtained (in particular when the thickness required for the half-turns 8 is small) by producing the half-turns using galvanic or silk-screen addition, or the like. In this case, a layer of conductive material is applied onto the outer surface of the container 1 and subsequently photoengraved. The resulting half-turns have a very small thickness and are stably applied to the container 1 without requiring resin bonding.

According to the above-described method, the component 21 is applied horizontally onto the printed circuit. In practice, this solution cannot always be implemented because of space constraints. In this case, the soldering pads 23, 25 and the connection tracks 24 can be provided on an intermediate support, to close and support the component 21. The intermediate support, which has a flat shape, is then applied at right angles to the board 22. In both cases, the container 1 is applied to a laminar support (which can be the board on which the printed circuit is provided, or the intermediate support for closure and support). In this case also, the main advantages of the present invention are obtained. In the case of application of the horizontal component 21 onto the printed circuit, the printed circuit itself includes the conductive tracks 24 disposed according to requirements. On the other hand, in the case when an intermediate support is used for closure and support, the latter can be produced in various versions, with conductive tracks 24 for connection between the soldering pads 23, 25, disposed according to various series/parallel configurations. By combining an intermediate support and a component 21 with the respective half-turns 8, it is possible to obtain reciprocal closure and connection of the turns according to specific design requirements.

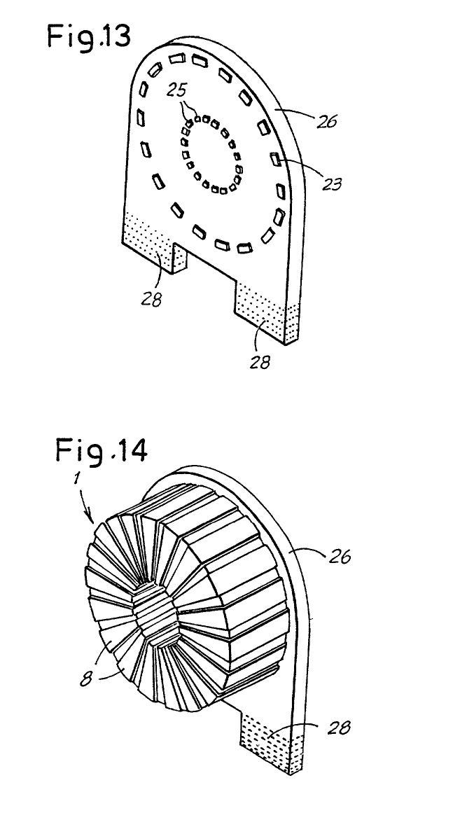

FIGS. 13 and 14 show an embodiment of an intermediate support 26 with soldering pads 24 and contacts 28. Contacts 28 may be used to form a mechanical and electrical connection between the intermediate support and the printed circuit. In FIG. 13, the intermediate support 26 is shown in isolation, whereas FIG. 14 also shows the container 1 mounted on the latter.

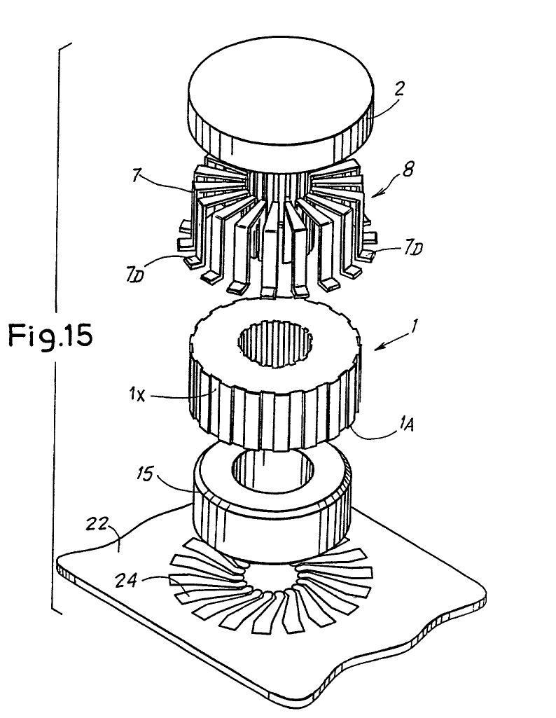

FIG. 15 shows an exploded view of a second embodiment of the present invention. In this case, the container 1 has on its outer cylindrical surface longitudinal grooves 1X, which form seats to accommodate the half-turns 8. The half-turns 8 have terminal ends that are folded in a direction pointing away from the inner space of the container 1, unlike the type shown in the previous embodiments. A ferro-magnetic core 15 is inserted in the inner space 3 of the container 1, and the printed circuit 22 includes conductive tracks 24. The half-turns 8 are stably connected to the container 1 by means of a cover 2 which is punched out and inserted above the half-turns 8 after the latter have been inserted in the individual seats formed by the grooves 1X. In alternative embodiments, the half-turns can be secured by resin bonding as well.

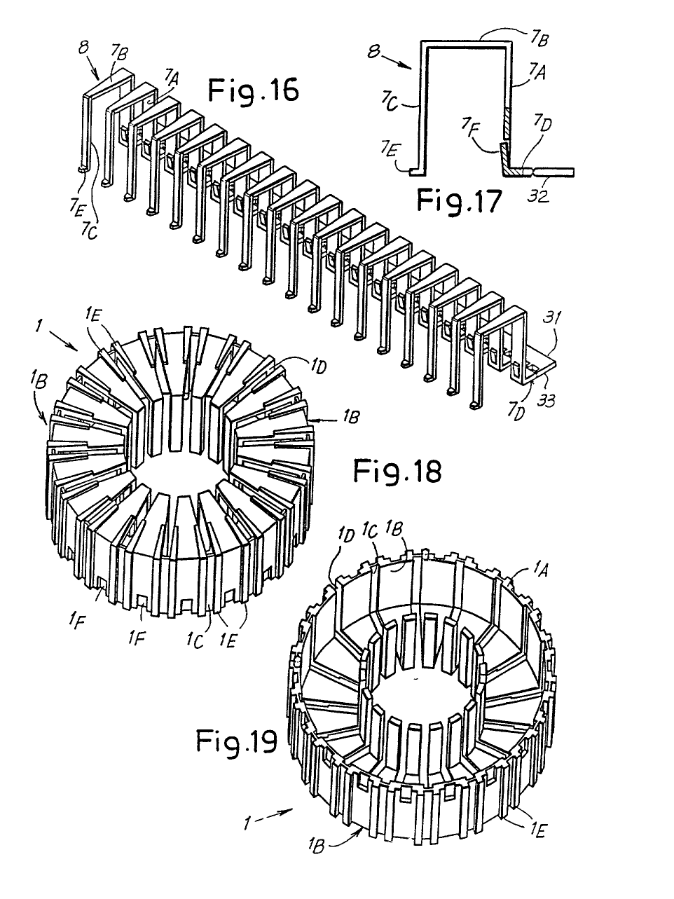

FIGS. 16 and 17 show a different embodiment of the segments 7 that form the half-turns 8. In this embodiment, the segments 7 are produced by punching and folding a rectangular latten, and are temporarily connected to one another by means of a longitudinal strip of latten 32 at the rupture points 33. References 7A, 7B and 7C again indicate the portions that form each individual segment 7 and references 7D and 7E indicate the folded terminal ends of the segments themselves. In this case, the folding is carried out in the direction pointing away from the space 3, around which the half-turns 8 are applied. This arrangement simplifies the subsequent soldering in comparison with the previous embodiment. In the example illustrated, each segment 7 (FIG. 17) includes a resilient retention tab 7F, which is produced by punching, the function of which is described hereinafter.

The strip of aligned half-turns 8 shown in FIG. 16 can be used as a loader for components in an assembly robot, which then inserts each individual half-turn 8 onto the container 1.

The segments 7 in FIGS. 16 and 17 are produced for use in association with a container 1 as shown in FIGS. 18 to 20. In this embodiment, the container 1 has a configuration in the form of panels 1B, which are connected to one another by joining portions 1C with a reduced thickness. At a radial plane, the container has a notch 1D, which corresponds to the absence of one of the joining portions 1C. The container 1 can be produced in linear form and then folded on itself in order to bring it into the annular shape shown in FIGS. 18 and 19, with the two end panels 1B abutting at the notch 1D.

Each panel 1B has a development that corresponds approximately to the development of the segments 7, with two lateral ribs 1E, which extend along the lateral cylindrical wall, and partially along the flat front wall of the container (see in particular FIG. 18). The lateral ribs 1E form retention seats for the half-turns 8. In addition, each panel 1B has a recess 1F in the vicinity of the lower edge 1A, for the purposes described hereinafter.

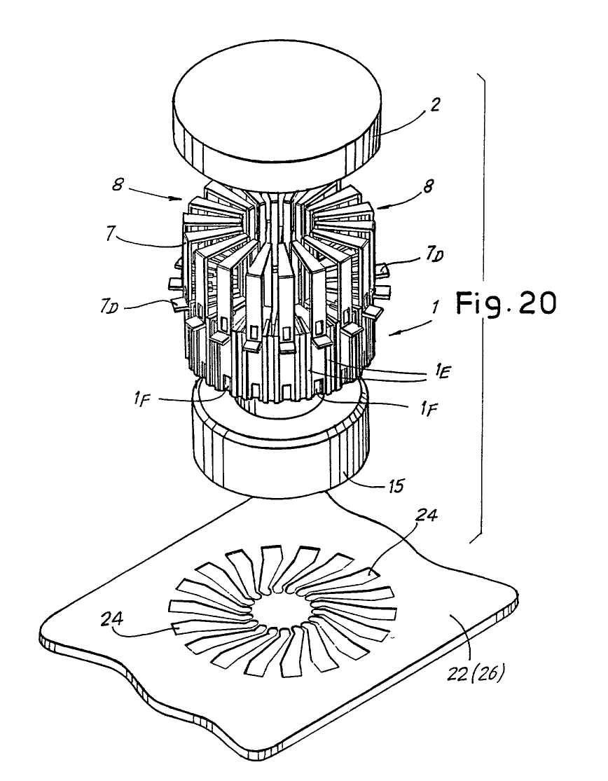

The exploded view in FIG. 20 illustrates the method of assembly of a third embodiment of the present invention produced with the half-turns 8 in FIGS. 16 and 17 and with the container in FIGS. 18 and 19. The half-turns 8 are inserted individually in the seats delimited by the lateral ribs 1E of each panel 1B that form the container 1 and the tabs 7F are inserted in the corresponding recesses 1F. By this means, each half-turn 8 remains correctly in its own position. A cover 2 and/or resin bonding may be used in order to stabilize the half-turns on the container 1. This embodiment also includes a ferro-magnetic core 15, a board 22 (or, alternatively, an intermediate support 26 for vertical mounting), and conductive tracks 24 that complete the turns.

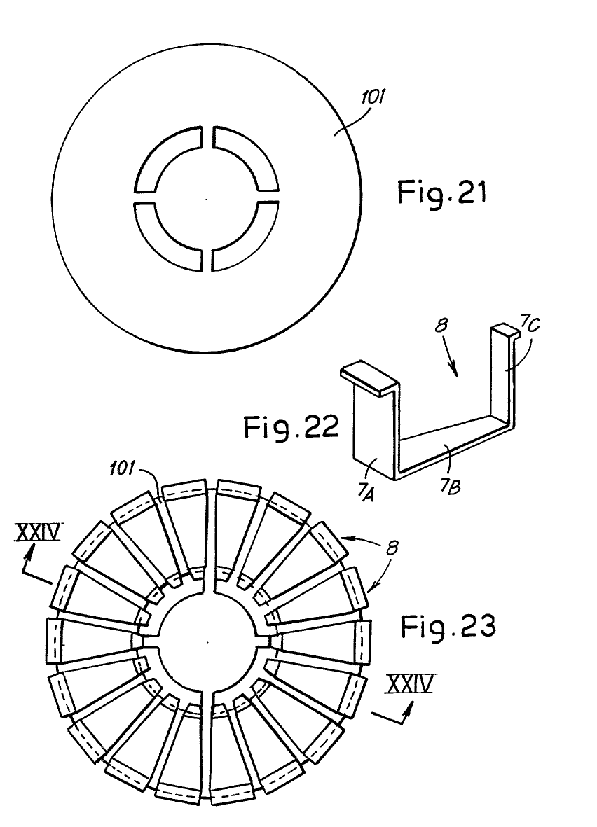

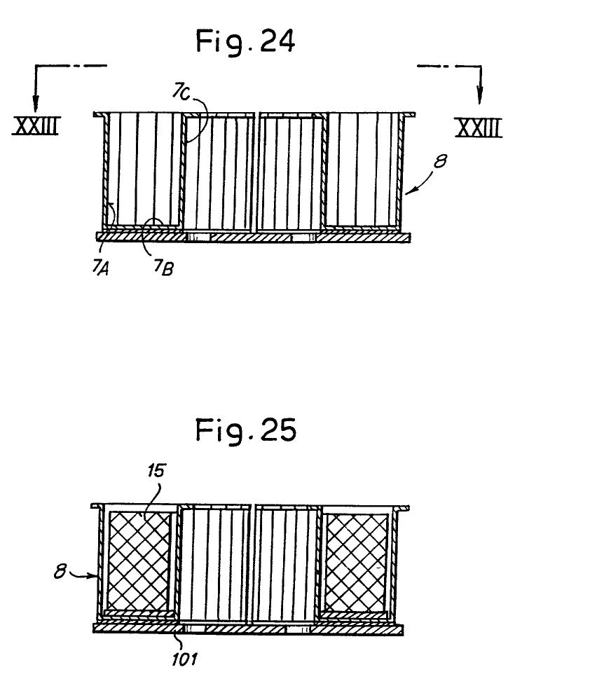

FIGS. 21 to 30 show a fourth embodiment of the present invention. According to this embodiment, the half-turns 8 are no longer mounted on a container 1. In this case, the support structure includes a simple disk-shaped laminar support component 101. The laminar component 101 has a central hole 101A that is partly occupied by a detachable plate, which is used simply to facilitate handling of the component 101 during assembly.

A plurality of half-turns 8 (see FIG. 22) are connected to one surface of the support component 101. Note that identical numbers in each figure indicate parts that are the same as those in the embodiments already described. The half-turns 8 are glued or soldered to the laminar support component 101. The glue can be applied in spots, or using the silk-screen process, in order to obtain the required distribution. If soldering is used, the soldering paste can be applied to a metallization layer previously applied to the surface of the laminar support component 101. The support component 101 can be produced from electrically insulating material, or from electrically conductive material if it has an insulating layer in order to prevent it from short-circuiting the half-turns. In the latter case, excellent thermal transmission is obtained, and accordingly, heat generated by the component is more easily dissipated.

In a variation of this embodiment, a ferro-magnetic core 15 is inserted inside the space defined by the branches of the “U” formed by the half-turns 8 (see FIG. 25). The ferro-magnetic core can be secured, for example by means of an adhesive, in the space formed by the half-turns. Since a container made of insulating material is not provided the ferro-magnetic core can be painted with an insulating paint in order to prevent electrical contact between the half-turns 8 and the ferro-magnetic core 15. This painting can be omitted if the ferro-magnetic material of the core 15 has sufficiently low electrical conductivity.

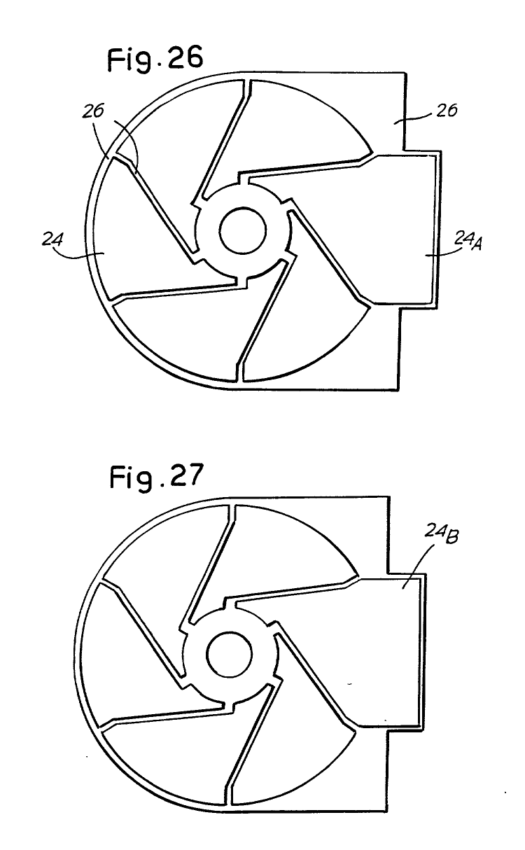

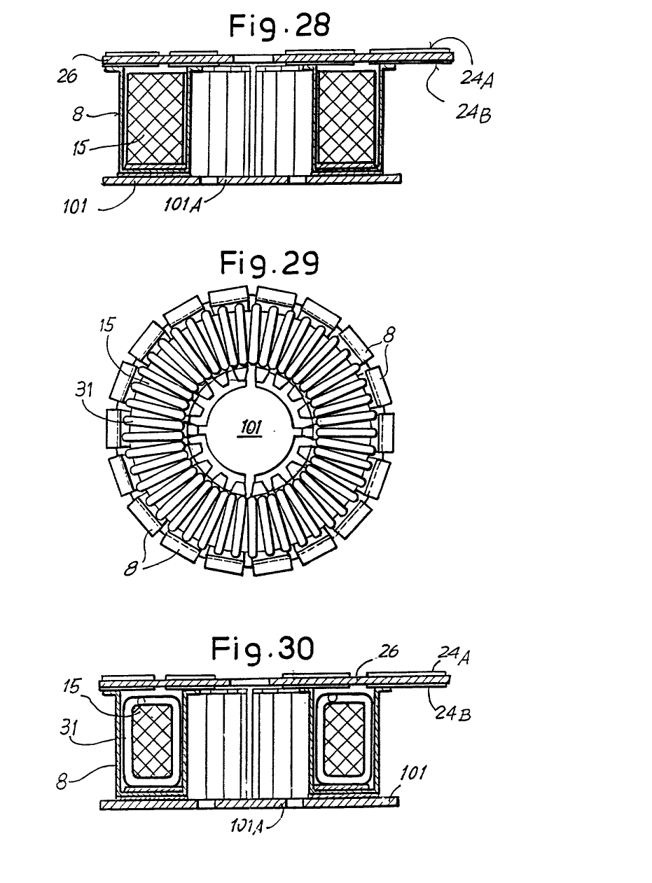

The assembly thus obtained is mounted on a laminar support, which is again indicated as 26 (FIGS. 26, 27, 28) and is similar to that shown in FIGS. 13 and 14. The laminar support 26 also includes a plurality of conductive tracks 24. Two contacts 24A, 24B respectively, which constitute the electrical and mechanical connections for vertical mounting of the support 26 on an electronic board are provided on both surfaces of the laminar support 26. As an alternative, the assembly in FIG. 25 can be mounted horizontally, directly on the electronic board, in which case the conductive tracks 24 are produced directly on the electronic board.

FIG. 28 shows the complete component, with resin bonding, which encloses the internal components. As can be seen in the cross section in FIG. 28, the component has an axial hole, corresponding to the hole 101A in the laminar support component 101. This axial hole allows a thermal dissipator to be connected to the surface of the support component 101. By means of this arrangement, the half-turns 8, the laminar support component 101, and optionally the thermal dissipator, which is applied to the latter, permit efficient extraction and dispersal of the heat generated inside the component into the environment.

FIGS. 29 and 30 show the same component as that shown in FIG. 28. In FIG. 29, the component is in an intermediate assembly step, before application of the laminar support 26, and includes a ferro-magnetic core 15 and a winding 31, similar to the winding shown in FIG. 11, wrapped around the ferro-magnetic core 15.

It will be appreciated that the drawings show only practical embodiments of the invention, the shapes and arrangements of which can be varied without departing from the basic concept of the invention.

The invention claimed is:

1. A method of producing an electrical component, comprising the steps of:
folding a plurality of segments of electrically conductive material partially around a container to form a plurality of half-turns; and
connecting the plurality of half-turns to the container.

2. The method of claim 1, further comprising the steps of:
cutting the plurality of segments out of a sheet of electrically conductive material so that the segments are arranged in a dial-shaped pattern with one end of each segment connected to an inner ring and another end of each segment connected to an outer ring; and
detaching each segment from the inner and outer rings.

3. The method of either of claim 2, wherein the step of folding the plurality of segments includes the steps of:
folding a first portion connected to an intermediate portion of each segment down against a first upper edge of the container; and
folding a second portion connected to the intermediate portion of each segment down against a second upper edge of the container

4. The method of claim 3, further comprising the steps of:
folding a third portion connected to the first portion of each segment inward against or outward away from a first lower edge of the container; and
folding a fourth portion connected to the second portion of each segment inward against or outward away from a second lower edge of the container.

5. The method of claim 4, further comprising the step of inserting a ferro-magnetic core into the container.

6. The method of claim 5, further comprising the step of wrapping an electrically conductive wire around the ferro-magnetic core.

7. The method of claim 5 wherein the step of connecting the plurality of half-turns to the container comprises the step of connecting the plurality of half-turns in two electrically insulated layers.

8. The method of claim 7, wherein the step of connecting the plurality of half-turns in two electrically insulated layers comprises the steps of:
integrating a portion of the plurality of half-turns into the container; and
attaching the remaining half-turns to an outer surface of the container.

9. The method of claim 8, further comprising the step of connecting the combination of the container and the plurality of half-turns to a mounting structure by connecting the plurality of half-turns to a plurality of electrically conductive tracks on the mounting structure, the half-turns and the conductive tracks forming a plurality of electrically conductive turns.

10. The method of claim 9, further comprising the step of connected the turns in series, parallel, or a combination of series and parallel.

11. A method of producing an electrical component, comprising the steps of:
folding a plurality of segments of electrically conductive material into a plurality of u-shaped half-turns; and
connecting the plurality of half-turns to a container.

12. The method of claim 11, further comprising the step of punching the plurality of segments from a sheet of electrically conductive material.

13. The method of claim 11, further comprising the steps of:
forming the plurality of segments out of a strip of electrically conductive material; and
detaching each segment individually from the strip of material.

14. The method of claim 13, further comprising the step of inserting a ferro-magnetic core into the container.

15. The method of claim 14, further comprising the step of wrapping an electrically conductive wire around the ferro-magnetic core.

16. The method of claim 15, wherein the step of connecting the plurality of half-turns to the container comprises the step of connecting the plurality of half-turns in two electrically insulated layers.

17. The method of claim 16, wherein the step of connecting the plurality of half-turns in two electrically insulated layers comprises the steps of:
integrating a portion of the plurality of half-turns into the container; and
attaching the remaining half-turns to an outer surface of the container.

18. The method of claim 17, further comprising the step of connecting the combination of the container and the plurality of half-turns to a mounting structure by connecting the plurality of half-turns to a plurality of electrically conductive tracks on the mounting structure, the half-turns and the conductive tracks forming a plurality of electrically conductive turns.

19. The method of claim 18, further comprising the step of connected the turns in series, parallel, or a combination of series and parallel.

20. A method of producing an electrical component, comprising the steps of:
inserting a plurality of u-shaped half-turns of electrically conductive material into a plurality of seats defmed in a container; and
connecting the plurality of half-turns to the container.

21. The method of claim 20, further comprising the steps of:
producing a plurality of segments of electrically conductive material detachably connected to one another;
folding the plurality of segments to form the plurality of u-shaped half-turns; and
separating the plurality of u-shaped half-turns from each other.

22. The method of claim 21, further comprising the steps of:
producing a plurality of panels connected together linearly using a plurality of joining portions; and
folding the plurality of panels and joining portions together to form the container.

23. The method of claim 22, wherein the plurality of half-turns are connected to the container using a cover, resin bonding, or both.

24. The method of claim 23, wherein the step of inserting the plurality of half-turns into a plurality of seats comprises the step of:
inserting the half-turns into a plurality of grooves defined in an outer side wall of the container and a plurality of grooves defined in an inner side wall of the container.

25. The method of claim 23, wherein the step of inserting the plurality of half-turns into a plurality of seats comprises the step of:
inserting the half-turns into a plurality of grooves defined in a plurality of outer side walls of the container and a plurality of grooves extending partially along a plurality of front walls of the container.

26. The method of claim 25, further comprising the step of inserting a plurality of resilient tabs defined in each half-turn into a plurality of recesses defined in each outer side wall of the container.

27. The method of claim 26, further comprising the step of inserting a ferro-magnetic core into the container.

28. The method of claim 27, further comprising the step of wrapping an electrically conductive wire around the ferro-magnetic core.

29. The method of claim 28, further comprising the step of connecting the combination of the container and the plurality of half-turns to a mounting structure by connecting the plurality of half-turns to a plurality of electrically conductive tracks on the mounting structure, the half-turns and the conductive tracks forming a plurality of electrically conductive turns.

30. The method of claim 29, further comprising the step of connecting the turns in series, parallel, or a combination of series and parallel.

31. A method of producing an electrical component, comprising the steps of:
applying a bonding substance to a support structure; and
connecting a plurality of u-shaped half-turns to the support structure using the bonding substance.

32. The method of claim 31, further comprising the step of connecting a thermal dissipater to the support structure.

33. The method of claim 32, further comprising the step of removing a detachable plate from the support structure.

34. The method of claim 33, further comprising the step of applying a metallization layer to one side of the support structure.

35. The method of claim 34 further comprising the step of inserting a ferro-magnetic core into a u-shaped opening formed by the plurality of u-shaped half-turns.

36. The method of claim 35, further comprising the step of covering the ferro-magnetic core with an insulating paint.

37. The method of claim 36, further comprising the step of wrapping an electrically conductive wire around the ferro-magnetic core.

38. The method of claim 37, further comprising the step of connecting the combination of the support structure and the plurality of half-turns to a mounting structure by connecting the plurality of half-turns to a plurality of electrically conductive tracks on the mounting structure, the half-turns and the conductive tracks forming a plurality of electrically conductive turns.

39. The method of claim 38, further comprising the step of connected the turns in series, parallel, or a combination of series and parallel.

40. An electrical component, comprising:
a container; and
a plurality of segments of electrically conductive material connected to the container forming a plurality of u-shaped half-turns, each half-turn including an inner portion extending past an inner lower edge of the container and an outer portion extending past an outer lower edge of the container.

41. The electrical component of claim 40, wherein the portions extending past the lower edges of the container are folded toward each other or folded away from each other.

42. The electrical component of claim 41, wherein the plurality of half-turns are separated into two electrically insulated layers of half-turns.

43. The electrical component of claim 41, wherein the plurality of half-turns are integrated into the container.

44. The electrical component of claim 43, further comprising a ferro-magnetic core inserted into the container.

45. The electrical component of claim 44, further comprising an insulated electrically conductive wire wrapped around the ferro-magnetic core.

46. The electrical component of claim 45, further comprising;
a mounting structure having a plurality of electrically conductive tracks; and
wherein the combination of the container and the plurality of half-turns is mounted on the mounting structure by connecting the half-turns to the conductive tracks, the half-turns and conductive tracks forming a plurality of turns.

47. The electrical component of claim 46, wherein the turns are connected in series, parallel, or a combination of series and parallel.

48. An electrical component, comprising:
a container having a plurality of seats defined therein; and
a plurality of u-shaped half-turns of electrically conductive material connected to the container using the seats.

49. The electrical component of claim 48, wherein:
each u-shaped half-turn includes a intermediate portion connected to two arms; and
each vertical arm further includes a tab extending outward away from each arm.

50. The electrical component of claim 49, wherein the u-shaped half-turns are connected to the container using a cover, resin bonding, or both.

51. The electrical component of claim 50, wherein the plurality of seats comprises a plurality of grooves defined in an outer surface of the container and an inner surface of the container.

52. The electrical component of claim 50, wherein the plurality of seats comprise a plurality of grooves defined in a plurality of outer side walls of the container and a plurality of grooves extending partially along a plurality of front walls of the container.

53. The electrical component of claim 52, further comprising:
a plurality of resilient tabs defined in each half-turn;
a plurality of recesses defined in the container; and
wherein each resilient tab is inserted into one of the recesses.

54. The electrical component of claim 53, further comprising a ferro-magnetic core inserted into the container.

55. The electrical component of claim 54, further comprising an electrically conductive wire wrapped around the ferro-magnetic core.

56. The electrical component of claim 55, further comprising:
a mounting structure having a plurality of electrically conductive tracks; and
wherein the combination of the container and the plurality of half-turns is mounted on the mounting structure by connecting the half-turns to the conductive tracks, the half-turns and conductive tracks forming a plurality of turns.

57. The electrical component of claim 56, wherein the turns are connected in series, parallel, or a combination of series and parallel.

58. An electrical component, comprising:
a support structure; and
a plurality of half-turns of electrically conductive material connected to the support structure, each u-shaped half-turn including an intermediate portion connected to two arms, and each vertical arm further including a tab extending outward away from each arm.

59. The electrical component of claim 58, wherein the support structure includes a detachable plate.

60. The electrical component of claim 59, wherein the support structure includes electrically conductive material covered with an insulating layer.

61. The electrical component of claim 60, further comprising a ferro-magnetic core inserted into a u-shaped opening formed by the plurality of half-turns.

62. The electrical component of claim 61, further comprising an insulated electrically conductive wire wrapped around the ferro-magnetic core.

63. The electrical component of claim 62, wherein the ferro-magnetic core is covered with insulating paint.

64. The electrical component of claim 63, further comprising a thermal dissipater connected to the support structure.

65. The electrical component of claim 64, further comprising:
a mounting structure having a plurality of electrically conductive tracks; and
wherein the combination of the support structure and the plurality of half-turns is mounted on the mounting structure by connecting the half-turns to the conductive tracks, the half-turns and conductive tracks forming a plurality of turns.

66. The electrical component of claim 65, wherein the turns are connected in series, parallel, or a combination of series and parallel.
